(19) United States
(12) Patent Application Publication
(10) Pub. No.: US 2011/0014010 A1
(43) Pub. Date: Jan. 20, 2011

(54) WASHER WITH VULCANIZATE LAYER

(75) Inventor: Henry R. DeGraan, Poway, CA (US)

Correspondence Address: KNOBBE MARTENS OLSON & BEAR LLP, 2040 MAIN STREET, FOURTEENTH FLOOR, IRVINE, CA, 92614, US

(73) Assignee: Aztec Washer Company, Poway, CA (US)

(21) Appl. No.: 12/506,180

(22) Filed: Jul. 20, 2009

(51) Int. Cl. F16B 43/00; B21D 53/20

(52) U.S. Cl. 411/533; 411/531; 470/41

(57) ABSTRACT

Washers incorporating a vulcanized rubber deformable layer and methods of making the same. For example, a roofing washer can include an aperture for receiving a fastener, a deformable layer configured to conform to the surface of a roof, and an oppositely positioned backing layer. The backing layer can comprise a metallic material and the deformable layer can comprise a vulcanizate, for example, vulcanized ethylene propylene diene M-class (EPDM) rubber. A method of manufacturing a roofing washer can include providing a backing layer with a deformable vulcanizate layer.

### BACKGROUND

1. Field of the Inventions

Embodiments disclosed herein relate to hardware used to fasten one or more layers of roofing material, for example, metal roofing panels, to an underlayment, for example, a wooden roof and/or a roofing membrane and methods for making such fasteners. For example, certain embodiments include washers having a deformable vulcanizate sealing layer.

2. Description of the Related Art

Roofing panels or layers, for example metal panels, can be fastened to an underlayment, for example, wood and/or a roofing membrane layer, using threaded fasteners. In some cases, roofing washers may be used with common sandwich panel style construction used in harsh climates where additional insulation is required. In such cases, two layers of trapezoidal or corrugated metal panels are held together with an insulating material disposed between the two panels. The insulating layer can be between about 6 and about 10 inches.

In many cases, roofing washers are used to distribute the load from the threaded fastener over an area of the roofing panel that is larger than the head of the fastener. Existing roofing washers can include a backing layer and a sealing layer disposed opposite to the backing layer. The sealing layer can engage the roofing panel and be configured to form a partial seal around the aperture in the roofing panel that receives the stem or shank of the fastener. The seal formed between the washer and the roofing panel can prevent the ingress of liquid or particulate matter therethrough and/or minimize heat transfer through the seal. Accordingly, the seal between a roofing washer and a roofing panel can be important to protect the integrity of the underlayment and/or structure contained below the roof

Existing roofing washers include sealing layers comprising rubbers or polymers, for example, uncured ethylene propylene diene M-class rubber (“EPDM”). These materials can form a seal between the washer and roofing panel when the fastener is initially tightened to the underlayment.

### SUMMARY OF THE INVENTIONS

The devices and methods of this disclosure each have several aspects, no single one of which is solely responsible for their desirable attributes. Without limiting the scope of the claims, some prominent features will now be discussed briefly. After considering this discussion, and particularly after reading the section entitled “Detailed Description of Certain Embodiments,” one will understand how the features of the devices and methods disclosed herein provide advantages over other known devices and methods.

An aspect of at least one of the inventions disclosed herein includes the realization that curing a sealing layer of a washer can overcome certain problems. For example, existing sealing layers can have limited memory or recovery characteristics. Over time, the roofing panel can expand and contract in response to temperature changes and existing sealing layers can not move along with the panel resulting in gaps or voids in the seal. Existing sealing layers can also pull away from the washer backing and/or the roofing panel as the panels expand and contract.

Furthermore, the sealing layers used in existing washers cannot be powder coated because of the effects of high temperature on the materials. This creates inefficiencies in manufacturing roofing washers because the backing layers must be powder coated before the sealing layers are adhered to the backings and individual washers with sealing layers cannot be powder coated. Instead of producing a large quantity of washers and later powder coating a smaller batch of individual washers, the backing material has to be carefully measured, powder coated, and stamped before adhering the sealing layer to the stamped backing layers.

Sealing layers that cannot be powder coated can also present aesthetic concerns for users because the sealing layers can be differently colored than the backings. Backing layers with sealing layers adhered thereto can be individually painted using solvent based techniques. However, solvent based techniques are disfavored in environmentally friendly countries, for example, many countries in Europe.

Thus, in accordance with at least some of the embodiments disclosed herein, a washer is provided with a vulcanized sealing layer. By providing a washer with a vulcanized sealing layer, such a washer can be formed into its final shape, with the sealing layer attached, then further finished. For example, a finished washer with a contoured stamped rigid body and a vulcanized/cured sealing layer can be powder coated without destroying the sealing layer.

In accordance with other embodiments, a roofing washer can be used with a fastener having an elongated stem and a head at one end of the stem. The head can have an outer diameter that is greater than an outer diameter of the stem. The roofing washer can include a rigid backing layer configured to engage at least a portion of the fastener. The backing layer can have an aperture formed therein for receipt of at least a portion of the stem. The roofing washer can also include a deformable layer disposed on at least a portion of the backing layer. The deformable layer can have an aperture formed therein for receipt of at least a portion of the stem. The deformable layer aperture can be generally aligned with the backing layer aperture and the deformable layer can comprise a vulcanizate.

In accordance with other embodiments, a method of manufacturing a washer is disclosed. The method can include providing a generally planar uncured elastomer layer having a first surface and a second surface opposite the first surface. The method can also include providing a generally planar rigid backing layer and disposing the second surface of the uncured elastomer layer on the backing layer. The method can comprise vulcanizing the uncured elastomer layer to produce a vulcanizate layer disposed on the backing layer.

According to other embodiments, a washer can comprise a metallic backing layer having an aperture formed therein for receipt of at least a portion of an elongated threaded fastener. The elongated threaded fastener can have a stem and a head at one end of the stem. The washer can also include a memory foam layer having an aperture formed therein for receipt of at least a portion of the threaded fastener. The memory foam aperture can be generally aligned with the metallic backing layer aperture and the memory foam layer can be generally deformable. The washer can also include an adhesive layer disposed between at least a portion of the metallic backing layer and the memory foam layer.

### BRIEF DESCRIPTION OF THE DRAWINGS

FIG. 1 is a perspective view of an embodiment of a roofing washer.

FIG. 2 is a top plan view of the roofing washer of FIG. 1.

FIG. 3 is a front side view of the roofing washer of FIG. 1.

FIG. 4 is a bottom plan view of the roofing washer of FIG. 1.

FIG. 5 is a schematic diagram of a roto-cure machine which can be used to vulcanize uncured elastomer onto a backing layer to create a vulcanizate layer on the backing layer.

FIG. 6 is a cross-sectional view of the roofing washer of FIG. 1 distributing a load from a threaded fastener over an area of a roofing panel being secured by the fastener and roofing washer to an underlayment.

FIG. 7 is a cross-sectional view of the roofing washer of FIG. 1 over the roofing panel of FIG. 6 after the roofing panel has expanded.

FIG. 8 is a cross-sectional view of the roofing washer of FIG. 1 over the roofing panel of FIG. 6 after the roofing panel has contracted.

FIG. 9 is a block diagram schematically illustrating a method of making a washer including a vulcanizate layer.

FIG. 10 is a block diagram schematically illustrating a method of making a washer including a vulcanizate layer.

### DETAILED DESCRIPTION OF CERTAIN EMBODIMENTS

Embodiments disclosed herein relate to roofing washers used with threaded fasteners to secure roofing panels to an underlayment and methods of manufacturing the same, although the present inventions are not limited to this preferred application. Roofing washers can include a backing layer that a fastener head can be seated against and a sealing layer configured to conform to the roofing panel surface to form a seal between the fastener(s) and the roofing panel. Existing sealing layers comprise uncured or cured elastomers or rubbers with undesirable memory or hardness characteristics. The use of these materials in existing roofing washers presents problems with the integrity of seals over time, with manufacturing efficiency, and with aesthetics.

To address the limitations in current roofing washers, new washers and methods of making washers are described herein that incorporate a deformable sealing layer comprising a vulcanized material (“vulcanizate”). Vulcanization refers to a curing process where heat and pressure are applied over time.

When vulcanizing elastomers, heat and pressure are used to cross-link polymer molecules by atomic bridges. In some cases, a foaming agent or blowing agent can be used during the vulcanization process. A foaming agent can be added to or infused with an elastomer and decompose when heat and pressure are applied resulting in the evolution of nitrogen, carbon monoxide, carbon dioxide, and/or ammonia gases which are trapped in the elastomer to form a foamed article.

Decomposed gas can be allowed to expand controllably within the elastomer to produce foams with desirable cell sizes by achieving an optimum level of tensile properties at elevated temperatures by cross-linking the polymer molecules. Vulcanizates have many desirable characteristics including limited absorption of water, resistance to heat, resistance to ultraviolet radiation, resistance to chemicals, and memory.

Roofing washers incorporating a deformable vulcanizate layer can address sealing limitations in existing roofing washers stemming from the limited memory of existing sealing layers. One such limitation arises when roofing panels expand and contract due to changes in temperature. To maintain a proper seal between the fixed fastener head and the moving roofing panel, the sealing layers in roofing washers must expand when the roofing panels contract and contract when the roofing panels expand.

Roofing washers incorporating a vulcanizate layer can also address manufacturing limitations in existing roofing washers stemming from the inability to powder coat certain elastomers, for example, certain cured foamed elastomers. To provide flexibility in manufacturing batches of washers of various quantities and colors, it is desirable to manufacture a large quantity of un-painted washers and then powder coat any number of washers to match the requirements of a particular order. Powder coating requires high temperatures and thus, certain elastomers, for example, cured foamed elastomers, cannot be powder coated without damaging the elastomer layer. Therefore, existing manufacturing processes require a manufacturer to measure out a certain amount of backing material, stamp and powder coat the backing material, and then adhere sealing layers to each stamped piece of backing material to produce a finished washer. Embodiments disclosed herein can remedy the sealing and manufacturing limitations that exist with existing roofing washers by using a deformable vulcanizate material as the sealing layer.

Embodiments are described below with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention can include several novel features, no single one of which is solely responsible for its desirable attributes or which is essential to practicing the inventions herein described.

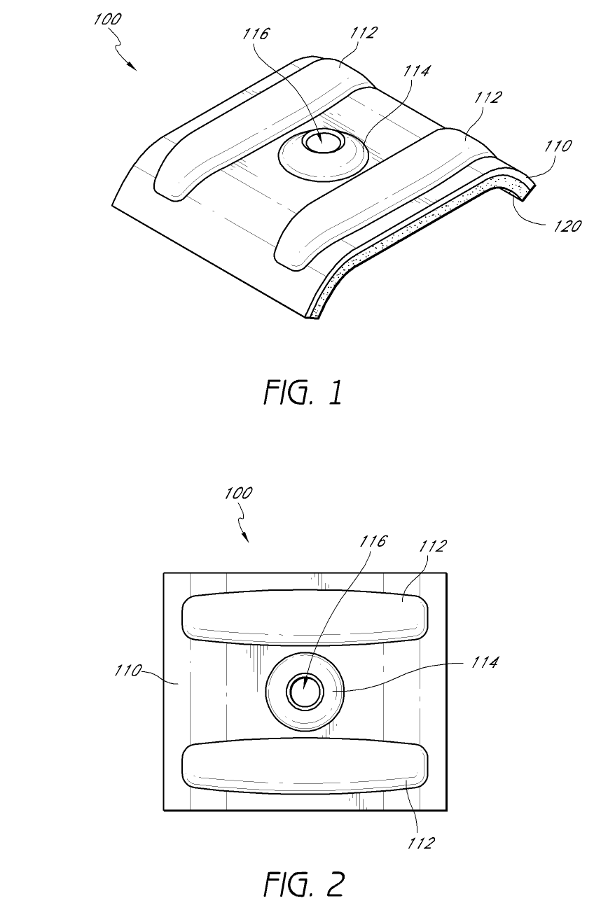

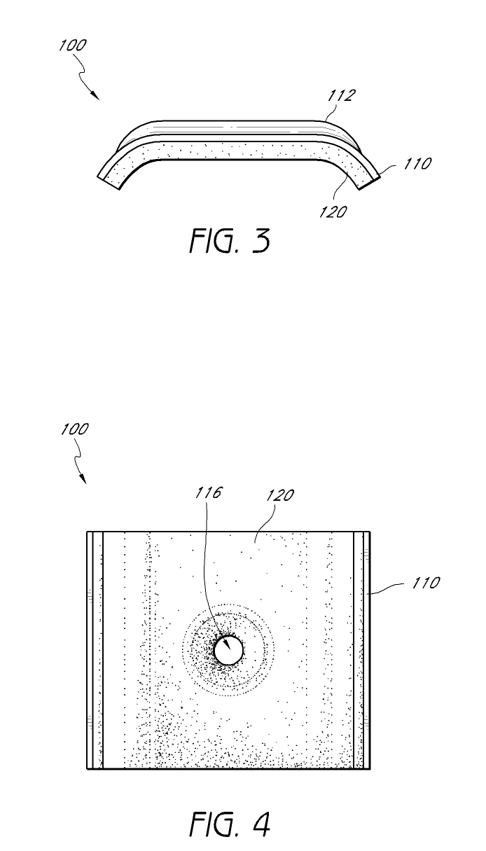

FIGS. 1-4 illustrate a roofing washer 100 including a backing layer 110 and a deformable sealing layer 120. As shown in FIG. 3, in some embodiments the washer 100 can be generally U-shaped and configured to receive at least a portion of a surface, for example, a portion of a crest of a metallic roofing panel. In some embodiments, the washer 100 can be generally planar and configured to engage another generally planar surface, for example, a generally planar roofing panel or a generally planar portion of a roofing panel. In other embodiments, the washer 100 can be generally trapezoidal, generally polygonal, generally curvilinear, and/or irregularly shaped depending on the shape of the surface to be fastened.

FIG. 2 shows a top plan view of a washer 100 having a generally polygonal shape. The shape of the washer 100 viewed from the top can also vary. In some embodiments, the shape of the washer 100 viewed from the top can be square, rectangular, triangular, generally round, generally curvilinear, oval, circular, symmetric, asymmetric, and/or irregularly shaped. The shape of the washer 100 viewed from the top can depend in part on the load to be distributed and/or the shape and size of the roofing panel or surface to be fastened.

In some embodiments, at least one aperture 116 can be formed through at least a portion of the washer 100. As shown in FIGS. 1-4, a washer 100 can include a single round aperture 116 that is disposed generally in the center of the washer 100. However, in other embodiments, the locations and quantities of apertures 116 can vary. In one embodiment, a washer 100 includes more than one aperture 116. In some embodiments, apertures 116 can be disposed near the edges of the washer 100. The aperture 116 can be configured to receive at least a portion of a fastener, for example, a portion of a fastener stem or shank. Accordingly, in some embodiments, the size and shape of the aperture 116 can vary depending on the size and/or shape of the portion of the fastener to be received through the aperture 116.

For example, in some embodiments the aperture 116 can be configured to receive a fastener shank having a diameter of about 0.25 inches and the aperture can be sized to be slightly larger than about 0.25 inches. As shown in FIG. 1-4, the aperture 116 can be generally circular. However, in other embodiments, the aperture 116 can be generally oval, generally round, generally curvilinear, generally polygonal, irregularly shaped, symmetric, and/or asymmetric depending on the shape of the portion of the fastener intended to be received through the aperture 116.

The size of the washer 100 can vary depending upon the intended application for the washer. In some embodiments, the size of the washer can depend on the size of the fastener shank the washer 100 is configured to receive. For example, in some embodiments, a washer 100 can be configured to receive a fastener having a shank or stem with a diameter of about 0.25 inches and the minimum width of the washer 100 must be greater than at least about 0.25 inches. In some embodiments, the size of the washer 100 can depend on the size of the fastener head.

Washers 100 can be generally configured to distribute a load from a fastener head over an area that is larger than the area of the fastener head. Accordingly, washers 100 can be sized depending on the size of the intended fastener head, the intended load to be distributed, the surface the washer 100 is configured to engage, and/or the size of the fastener shank.

As shown in FIG. 1, in some embodiments, a washer 100 can include a seating portion 114 that surrounds at least a portion of the aperture 116. In some embodiments, the seating portion 114 can be generally conical, generally pyramidal, generally curvilinear, generally polygonal, or frustum shaped (e.g., in the shape of a truncated cone or pyramid). In other embodiments, the seating portion 114 can vary in shape and/or size from the illustrated seating portion. In some embodiments, the seating portion 114 can be generally centered around the aperture 116. In some embodiments, the seating portion 114 can be configured to engage a portion of a fastener head.

In other embodiments, the seating portion 114 can be configured to engage another washer disposed between the roofing washer 100 and a fastener head. The shape and size of the seating portion 114 can be chosen based on the size and/or shape of the surface the seating portion 114 is configured to engage. In some embodiments, the shape of the seating portion 114 can facilitate a generally uniform distribution of a load from a fastener head across an area defined by at least a portion of the washer 100.

In some embodiments, roofing washers 100 can include one or more reinforcing ribs or members 112 configured to provide strength and/or support to the washer 100. Reinforcing ribs 112 can reduce the amount of backing material required to produce a washer 100 by reinforcing the backing in critical areas or along certain directions. The quantity, size, shape, and locations of reinforcing ribs 112 can vary. In the illustrated embodiment, the washer 100 includes two reinforcing ribs 112 disposed generally parallel to one another on opposite sides of the aperture 116. However, in other embodiments, different configurations can be employed to provide support and strength to a washer 100.

The backing layer 110 can be made out of various materials. Examples of suitable materials include, but are not limited to, composite materials, aluminum, stainless steel, brass, copper, silicone bronze, bronze, galvanized steel, monel, zinc, other metals, and combinations thereof The thickness of the backing layer 110 can vary. In some embodiments, the thickness can be between about 0.015 inches and about 0.125 inches. The thickness of the backing layer 110 can vary across the washer 100. For example, the thickness of a reinforcing rib 112 can be greater than the thickness of the backing layer 110 at another location.

The sealing layer 120 can be made out of various materials. Examples of suitable materials include, but are not limited to, foams, cured polymers, cured elastomers, cured rubbers, vulcanized elastomers, vulcanized polymers, other vulcanizates, and combinations thereof The sealing layer 120 can be formed by vulcanizing a starting material that is infused with or contains a suitable foaming agent. Examples of suitable starting materials include, but are not limited to, EPDM, neoprene, uncured rubbers, elastomers, and/or blends of polymers. In some embodiments, blends of olefinic polymers can be used as starting materials to formulate suitable foamed vulcanizates. Examples of suitable blends of olefinic polymers include, but are not limited to substantially linear poly(ethylene-co-1-octene)/substantially linear poly (ethylene-co-1-propene) blends, linear poly(ethylene-co-1-octene)/substantially linear poly(ethylene-co-1-butene) blends, linear poly(ethylene-co-1-octene)/linear poly(ethylene-co-1-hexane) blends, substantially linear poly(ethylene-co-1-octene)/poly(ethylene-co-vinylacetate) blends, and linear poly(ethylene-co-1-octene)/poly(ethylene-co-vinylacetate blends. Suitable olefinic blends used as starting materials can also contain minority amounts (<50 wt percent based on the weight of the blend) of scission-prone polymers, for example, polypropylene.

Starting materials can be combined with suitable exothermic foaming agents to produce a foam upon vulcanization. Examples of suitable foaming agents include, but are not limited to, azodicarbonamide, azodiisobutyronitrile, 4,4-oxybenzene sulfonylsemicarbazide, and p-toiuene sulfonylsemicarbazide. Foaming agents can be provided in solid form so that they can be easily dry-blended with the starting material(s). In some embodiments, foaming agents are blended with a starting material in an amount sufficient to evolve from about 0.5 to about 3 moles of gas or vapor per kilogram of starting material. In one embodiment, dry azodicarbonamide is blended with EPDM and then vulcanized to produce a sealing layer.

The thickness of the sealing layer 120 can vary. In some embodiments, the sealing layer 120 can have generally the same thickness as the backing layer 110. In other embodiments, the thicknesses of the backing layer 110 and the sealing layer 120 can be generally different. For example, the sealing layer 120 can be about twice as thick as the backing layer 110. The sealing layer 120 and the backing layer 110 can be coupled together using any suitable technique. In some embodiments, the sealing layer 120 is adhered to the backing layer 110 using a suitable adhesive, for example, Chemlok® 250 available commercially from LORD Corporation. In other embodiments, other methods of coupling the sealing layer 120 and backing layer 110 together are utilized. The top surface area of the sealing layer 120 can also vary. In some embodiments, the sealing layer 120 can be sized to have substantially the top surface area as the backing layer 110. In various embodiments, the sealing layer 120 can have a top surface area that is substantially less than the top surface area of the backing layer 110. In one embodiment, the sealing layer 120 can form a ring with an inner diameter and an outer diameter that runs generally along the perimeter of the backing layer 110.

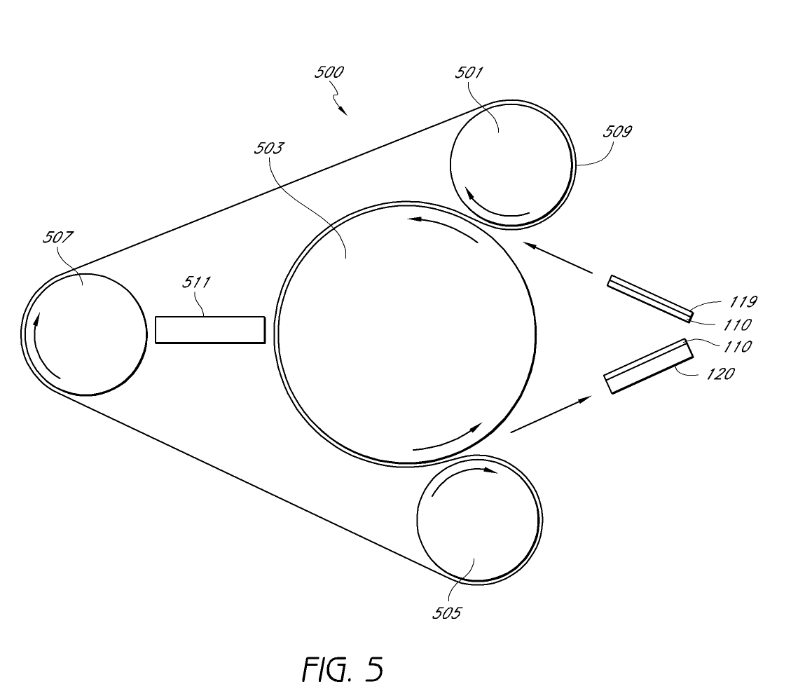

With reference to FIG. 5, a roto-cure machine 500 can be configured to vulcanize an uncured elastomer 119. Those of skill in the art will understand that various other embodiments of roto-cure machines or vulcanizing devices can be employed to achieve similar or different results.

The roto-cure machine 500 can include a heating drum 503, an infeed drum 501, an outfeed drum 505, a belt tension cylinder 507, a belt 509, and a radiator 511. The belt tension cylinder 507 is configured to drive the belt 509 and control the tension of the belt over the infeed drum 501, heating drum 503, and outfeed drum 505. The outfeed drum 505 and infeed drum 501 are positioned such that the belt 509 wraps around a portion of the heating drum 503 between the infeed drum and outfeed drum. This allows a user to input a piece of material, for example, a piece of uncured elastomer disposed over a metallic backing layer, in between the infeed drum 501 and heating drum 503 such that the material is compressed between the belt 509 and the heating drum 503. The radiator 511 is located near the heating drum 503 to apply heat to at least the portion of the heating drum 503 that the belt 509 wraps around. In some embodiments, the radiator 511 can be an infrared radiator or can use heated oil or steam to transfer heat to the heating drum 503. Other configurations can also be used.

The configuration schematically depicted in FIG. 5 subjects materials that are input between the infeed drum 501 and heating drum 503 to heat and pressure before the materials are ejected from the roto-cure machine 500 between the outfeed drum 505 and the heating drum 503. The amount of heat applied by the radiator 511, the speed of the belt 509, and the tension of the belt 509 can all be adjusted independently to vulcanize different materials input into the machine 500 or two achieve different vulcanization results with the same input materials.

In some embodiments, the roto-cure machine 500 can be configured to heat an uncured elastomer at about 370 degrees Farenheit for about 6 minutes and 30 seconds at a pressure of about 170 pound per square inch to vulcanize the elastomer. As discussed above, different heats, pressures, and times can be applied in various other embodiments. The dimensions of the infeed drum 501, heating drum 503, outfeed drum 805, belt tension cylinder 507 and belt 509 can vary.

In some embodiments, the heating drum 503 can have a diameter sized to subject an input material to a rotation of more than 180 degrees before ejection from the machine 500. In other embodiments, the heating drum 503 can be differently sized or positioned to subject an input material to more or less rotation.

With continued reference to FIG. 5, an uncured elastomer layer 119 disposed on a backing layer 110 is depicted according to one embodiment. In one embodiment, the uncured elastomer 119 comprises EPDM with a foaming agent, for example, azodicarbonamide, and the backing layer comprises a metal, for example, aluminum. In various embodiments, the uncured elastomer 119 can be coated with an adhesive, for example, Chemlok® 250 on a first surface before the first surface is disposed over the backing layer 110. The uncured elastomer 119 and backing layer 110 can be input together into the roto-cure machine 500 to vulcanize or cure the uncured elastomer 119 and produce a vulcanizate layer 120. The vulcanizate layer 120 depicted in FIG. 5 is disposed on a backing layer 110 and has been ejected from the roto-cure machine 500 after being subjected to heat and pressure over time.

Comparing the vulcanizate layer 120 to the uncured elastomer layer 119 shows the change in volume the elastomer 119 undergoes during the vulcanization/roto-curing process. In some embodiments, the vulcanizate layer 120 can be between about 2 and about 4 times as thick as the uncured elastomer layer 119. This increased thickness can result in a vulcanizate layer 120 having a greater memory than the uncured elastomer layer 119 while maintaining other desirable characteristics.

In some embodiments, the roto-cure machine 500 can be configured to produce a memory foam vulcanizate when certain materials, for example, uncured EPDM mixed with a foaming agent, are input into the machine. As discussed below, the vulcanizate layer 120 can form a superior seal between the backing layer 110 and another surface than the uncured elastomer layer 119.

After ejection from the roto-cure machine 500, the vulcanizate layer 120 and backing layer 110 can be stamped or machined to form a plurality of individual washers. The washers can comprise different sizes and shapes depending upon their intended applications. In one embodiment, the washers can comprise roofing washers, for example, saddle washers or cyclone washers. After stamping or machining, the washers can be individually powder coated without harming the vulcanizate layer 120.

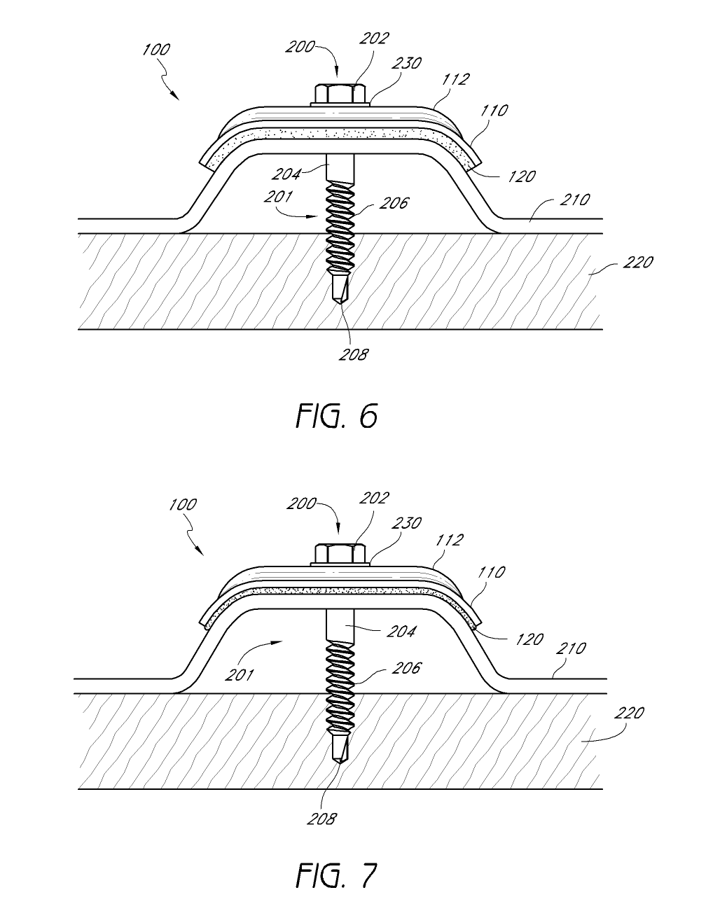

As discussed above, the sealing layer 120 can form a seal between a fastener and a roofing panel to prevent water and/or other contaminants from passing therethrough. Additionally, deformable vulcanizate sealing layers allow a user to apply a high torque to a fastener without damaging the surface underneath the washer 100 because of cushioning and increased flexibility. FIGS. 6-8 schematically illustrate how a vulcanizate sealing layer 120 can deform along with a roofing panel 210 to maintain a seal between the washer 100 and panel 210.

FIG. 6 schematically depicts a fastener 200 and roofing washer 100 securing a roofing panel 210 to an underlayment 220. The roofing washer 100 includes a rigid backing layer 110, a deformable vulcanizate sealing layer 120, and an aperture extending therethrough configured to receive at least a portion of the fastener 200. The fastener 200 can include a head 202 and a shank or stem 201 extending therefrom. The shank can include a threaded portion 206, a non-threaded portion 204, and/or a tip or point 208 situated opposite the head 202. An optional washer 230, for example, a sealing washer, can be disposed between the head 202 and the backing layer 110. The aperture in the roofing washer 100 can be generally aligned with a similarly shaped aperture in the roofing panel 210. In some embodiments, the roofing panel 210 can not be provided with an aperture and one or more apertures can be later formed therein. In some embodiments, an optional spacer (not shown) can be disposed between the roofing panel 210 and the underlayment 220 to maintain a certain distance between the two. Also, in various embodiments, the fastener 200 can be threaded into a threaded receptacle, nut, or tightening member (not shown).

The roofing washer 100 can rest on a portion of the roofing panel 210, for example, a crest. The roofing panel 210 can be formed of various materials, for example, polymers, composite materials, organic materials, recycled materials, and/or metals. The roofing panel 210 can cover a portion of the underlayment 220. In some embodiments, the underlayment 220 can comprise a roof The underlayment 220 can include one or more layers. In one embodiment, the underlayment 220 is a single wood layer. In another embodiment, the underlayment 220 includes a wood layer and a rubber membrane layer disposed over the wood layer.

Still referring to FIG. 6, the fastener 200 is threaded into the underlayment 220 such that the head 202 engages the washer 230 disposed between the backing layer 110. The washer 230 and backing layer 110 prevent the shank 201 from further entering the underlayment and the fastener 200 secures the roofing panel 210 to the underlayment 220. The head 202 can be tightened to a specific torque value or hand tightened. As the head 202 is tightened against the washer 2300, the vulcanizate sealing layer 120 is compressed and deforms to create a seal between the backing layer 110 and the roofing panel 210. The extent to which the sealing layer 120 deforms depends in part upon the properties of the vulcanizate and/or on the torque applied to the head 202.

FIG. 7 shows the roofing washer 100, fastener 200, roofing panel 210, and underlayment 220 shown in FIG. 6 with the roofing panel 210 expanded slightly from its position in FIG. 6. As discussed above, roofing panels can expand and contract in response to temperature changes. The fastener 200 and head 202 can not expand and contract at the same rate as the roofing panel 210 and thus, the distance between the head 202 and roofing panel 210 can fluctuate over time. To maintain a seal between the backing layer 110 and roofing panel 210, it is important that the sealing layer 120 contracts when the roofing panel expands and expands when the roofing panel contracts. As shown in the illustrated embodiment, the foamed sealing layer 120 contracts when the roofing panel expands to maintain a seal.

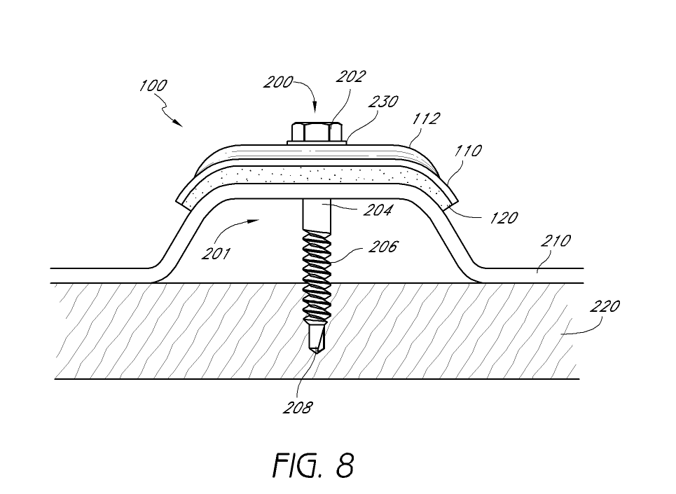

FIG. 8 shows the roofing washer 100, fastener 200, roofing panel 210, and underlayment shown in FIG. 6 with the roofing panel contracted from its position in FIG. 6. As shown in the illustrated embodiment, the sealing layer 120 has expanded from its shape in FIG. 6 to conform to the roofing panel 210 and maintain the seal between the backing layer 110 and the roofing panel. The sealing layer 120 can be configured to expand from its initial position in FIG. 6 because it is initially compressed in FIG. 6 as the head 202 is tightened and the vulcanizate has a memory. The memory of the sealing layer 120 will cause the layer to expand towards its initial (pre-compressed) size until it meets the contracted roofing panel 210 surface.

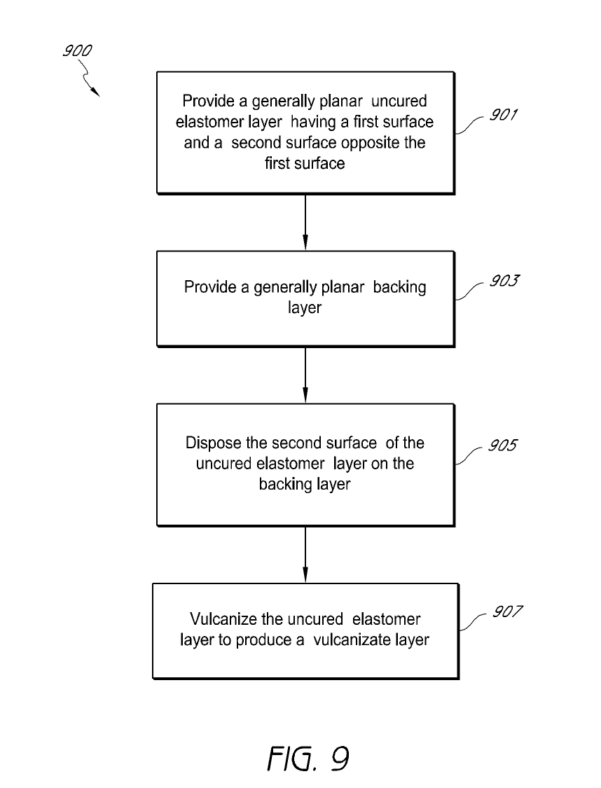

FIG. 9 is a block diagram depicting a method 900 of manufacturing a roofing washer, according to one embodiment. Method 900 includes the steps of providing a generally planar uncured elastomer layer having a first surface and a second surface opposite the first surface 901, providing a generally planar backing layer 903, disposing the second surface of the uncured elastomer layer on the backing layer 905, and vulcanizing the uncured elastomer layer to produce a vulcanizate layer 907. Performing the method 900 will form a roofing washer similar to the washer 100 depicted in FIGS. 1-4.

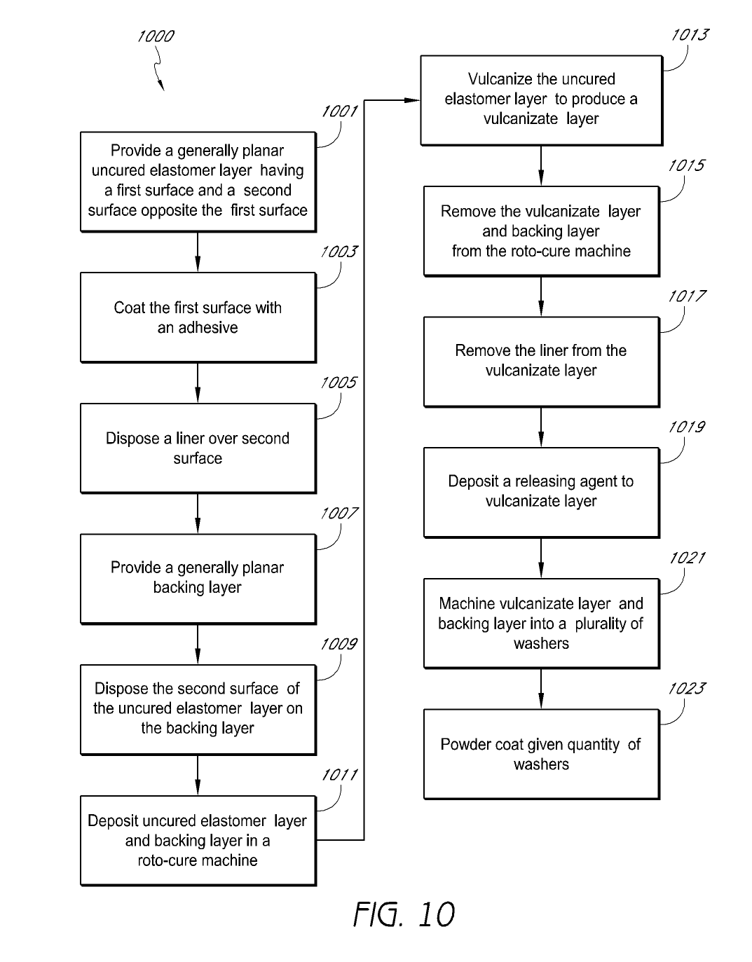

FIG. 10 is a block diagram depicting a method 1000 of manufacturing a roofing washer, according to one embodiment. Method 1000 includes the steps of providing a generally planar uncured elastomer layer having a first surface and a second surface 1001, coating the first surface with an adhesive 1003, disposing a liner over the second surface 1005, providing a generally planar backing layer 1007, disposing the second surface of the uncured elastomer on the backing layer 1009, depositing the uncured elastomer layer in a roto-cure machine 1011, vulcanizing the uncured elastomer layer to produce a vulcanizate layer 1013, removing the vulcanizate layer and backing layer from the roto-cure machine 1015, removing the liner from the vulcanizate layer 1017, depositing a releasing agent to the vulcanizate layer 1019, machining the vulcanizate layer and backing layer into a plurality of washers 1021, and powder coating a given quantity of washers 1023. Performing the method 1000 will form a plurality of roofing washers similar to the washer depicted in FIG. 1-4.

Still referring to FIG. 10, in some embodiments, the provided generally planar uncured elastomer layer can comprise a generally planar piece of uncured EPDM that comprises a solid foaming agent additive, for example, azodicarbonamide. The adhesive used to coat the first surface of the uncured elastomer layer can comprise any suitable adhesive for bonding an uncured elastomer to a rigid backing layer. In some embodiments, the backing layer provided can be metallic and Chemlok® 250 can be applied to the first surface of the uncured elastomer in order to adhere the layer to the backing layer. In some embodiments, in step 1005, a fabric heat resistant liner can be disposed over the second surface of the uncured elastomer to allow for a more uniform release of gas after vulcanization in order to prevent cobbing (e.g., a lumpy surface) on the vulcanizate layer. The backing layer provided in step 1007 can comprise any suitable rigid backing, for example, a composite material or metal.

Still referring to FIG. 10, the uncured elastomer layer and backing layer can be deposited in any roto-cure machine configured to vulcanize materials added therein. Suitable roto-cure machines are available commercially, for example, from Qingdao Yadong Rubber Machinery Group Co., Ltd. In some embodiments, the uncured elastomer layer can be vulcanized for about 6 minutes and 30 seconds at about 370 degrees Farenheit and at about 170 pounds per square inch to produce a vulcanizate layer. Additional methods of vulcanizing the uncured elastomer layer are known to those skilled in the art. In some embodiments, the releasing agent deposited in step 1019 can comprise a releasing agent configured to prevent warm vulcanizate layers from sticking to other surfaces, for example, to other warm vulcanizate layers. Applying a release agent to a vulcanizate layer can allow a person to store newly made vulcanizate layers by stacking the vulcanizate layers and attached backing layers on top of one another without worrying about sticking.

Still referring to FIG. 10, the vulcanizate layer and backing layer can be machined in step 1021 using a variety of methods. In one embodiment, the backing layer and vulcanizate layer are stamped into a plurality of individual washers. In other embodiments, different machining processes can be used to form a plurality of individual washers from a backing layer and vulcanizate layer. Once a plurality of washers has been machined, a given quantity of the washers can be powder coated with a certain color. Vulcanizate materials can be powder coated without damaging the materials unlike certain cured and uncured elastomers. Powder coating as used herein refers to a type of dry coating which is applied as a free-flowing dry powder to color an object. Powder coating is environmentally friendly because it does not require solvent to keep binder and filler parts in liquid suspension form. The dry powder is cured under heat to form a “skin” with a hard finish that is more durable than conventional solvent based painting techniques. Additionally, powder coating emits zero or near zero volatile organic compounds and overspray powder can be recycled for subsequent parts. As discussed above, powder coating a certain quantity of washers with a certain color is desirable from a manufacturing standpoint because it is easier to customize the quantity and color of batches as the powder coating process can be the last step in the manufacturing process.

The foregoing description details certain embodiments of the devices and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the disclosure should therefore be construed in accordance with the appended claims and any equivalents thereof

What is claimed is:

1. A roofing washer for use with a fastener having an elongated stem and a head at one end of the stem, the head having an outer diameter that is greater than an outer diameter of the stem, the roofing washer comprising:
a rigid backing layer configured to engage at least a portion of the fastener, the backing layer having an aperture formed therein for receipt of at least a portion of the stem; and
a deformable layer disposed on at least a portion of the backing layer, the deformable layer having an aperture formed therein for receipt of at least a portion of the stem, the deformable layer aperture being generally aligned with the backing layer aperture, the deformable layer comprising a vulcanizate.

2. The roofing washer of claim 1, wherein the deformable layer comprises vulcanized ethylene propylene diene M-class (EPDM) rubber.

3. The roofing washer of claim 1, wherein the vulcanizate is formed from ethylene propylene diene M-class (EPDM) rubber and a foaming agent.

4. The roofing washer of claim 3, wherein the foaming agent comprises azodicarbonamide.

5. The roofing washer of claim 1, wherein the deformable layer comprises vulcanized foam having a memory.

6. The roofing washer of claim 1, wherein the backing layer is metallic.

7. The roofing washer of claim 1, wherein the backing layer is selected from a group consisting of aluminum, stainless steel, brass, copper, silicone bronze, galvanized steel, monel, zinc, and combinations thereof.

8. The roofing washer of claim 1, further comprising a powder coat layer disposed over at least a portion of the backing layer and the deformable layer.

9. The roofing washer of claim 1, further comprising an adhesive layer disposed between at least a portion of the backing layer and at least a portion of the deformable layer.

10. The roofing washer of claim 1, wherein the deformable layer is configured to conform to a roofing panel surface as the fastener is seated in an underlayment.

11. The roofing washer of claim 1, wherein at least a portion of the backing layer is configured to distribute a load from the head of the fastener.

12. The roofing washer of claim 1, wherein the backing layer comprises reinforcing ribs.

13. The roofing washer of claim 1, wherein the roofing washer comprises a saddle washer.

14. A method of manufacturing a washer comprising:
providing a generally planar uncured elastomer layer having a first surface and a second surface opposite the first surface;
providing a generally planar rigid backing layer;
disposing the second surface of the uncured elastomer layer on the backing layer; and
vulcanizing the uncured elastomer layer to produce a vulcanizate layer disposed on the backing layer.

15. The method of claim 14, wherein the volume of the vulcanizate layer is at least two (2) times larger than the volume of the uncured elastomer layer.

16. The method of claim 14, wherein the volume of the vulcanizate layer is at least two and one-half (2.5) times larger than the volume of the uncured elastomer layer.

17. The method of claim 14, further comprising stamping the vulcanizate layer and backing layer to form a roofing washer.

18. The method of claim 17, further comprising powder coating the roofing washer.

19. The method of claim 14, wherein the uncured elastomer layer comprises ethylene propylene diene M-class (EPDM) rubber.

20. The method of claim 14, wherein the uncured elastomer layer comprises ethylene propylene diene M-class (EPDM) rubber and azodicarbonamide.

21. The method of claim 14, wherein the backing layer is metallic.

22. The method of claim 21, wherein the backing layer is selected from a group consisting of aluminum, stainless steel, brass, copper, silicone bronze, galvanized steel, monel, zinc, and combinations thereof.

23. The method of claim 14, further comprising disposing a liner over the first surface of the uncured elastomer layer.

24. The method claim 23, further comprising removing the liner from the vulcanizate layer.

25. The method of claim 23, wherein the liner comprises a heat resistant fabric.

26. The method of claim 14, further comprising applying an adhesive to at least a portion of the second surface of the uncured elastomer layer.

27. The method of claim 14, wherein the uncured elastomer layer is vulcanized for about six (6) minutes and thirty (30) seconds at about three hundred seventy (370) degrees Farenheit and about one hundred seventy (170) pounds per square inch.

28. The method of claim 27, wherein the uncured elastomer is vulcanized in a roto-cure machine.

29. The method of claim 14, further comprising applying a releasing agent to at least a portion of the vulcanizate layer.

30. A washer comprising:
a metallic backing layer having an aperture formed therein for receipt of at least a portion of an elongated threaded fastener, the fastener having a stem and a head at one end of the stem;
a memory foam layer comprising a vulcanizate, the memory foam layer having an aperture formed therein for receipt of at least a portion of the threaded fastener, the memory foam aperture being generally aligned with the metallic backing layer aperture, the memory foam layer being generally deformable; and
an adhesive layer disposed between at least a portion of the metallic backing layer and the memory foam layer.

31. The washer of claim 30, wherein the memory foam layer comprises a vulcanized elastomer.

32. The washer of claim 30, wherein the memory foam layer comprises vulcanized ethylene propylene diene M-class (EPDM) rubber.
